(19) United States
(12) Patent Application Publication
(10) Pub. No.: US 2026/0369901 A1
(43) Pub. Date: Nov. 19, 2026

(54) MULTI-STEP TAPERED GROUND CONNECTOR

(71) Applicant: Hubbell Incorporated, Shelton, CT (US)

(72) Inventor: Brian Royal Ellis, Dover, NH (US)

(21) Appl. No.: 19/425,155

(22) Filed: Dec. 18, 2025

Related U.S. Application Data
(60) Provisional application No. 63/739,937, filed on Dec. 30, 2024.

(51) Int. Cl. H01R 4/66

(52) U.S. Cl. CPC H01R 4/66

(57) ABSTRACT

The present disclosure provides embodiments of a ground connector for securing to a ground rod, the ground connector including a rod comprising a longitudinal passageway extending through at least a portion of the rod. The longitudinal passageway includes a first section having a first inner diameter, and a second section having a second inner diameter different than the first inner diameter, wherein the first section having the first inner diameter is nearest an opening to the passageway and transitions to the second section having the second inner diameter in a step-like manner.

### CROSS-REFERENCE TO RELATED APPLICATIONS

This application is based on and claims priority to U.S. Provisional Application Ser. No. 63/739,937 filed Dec. 30, 2024 entitled MULTI-STEP TAPPERED GROUND CONNECTOR, the contents of which are incorporated herein in their entirety by reference.

### TECHNICAL FIELD

The present disclosure relates generally to ground connectors and more particularly multi-step tapered ground connectors.

### DESCRIPTION OF THE RELATED ART

Ground rods are generally rigid metal members that are inserted into the earth. An electrical conductor is connected between the ground rod and an electrical device to electrically ground the electrical device. Ground rods provide a reliable path for dissipating excess electrical currents protecting people and property from potential hazards including electrical shock and fire. Various types of connectors may be used to secure the electrical conductor to the ground rod including, for example, interference/press fit connectors, clamp-on connectors, etc. While clamp-on connectors can provide effective connection to the ground rod, the connection may not be as effective in the long term. For example, clamp-on connectors may tend to relax after a period of time, particularly when the connector is placed underground. While interference/press fit connectors achieve effective connection to the ground rod even when placed under ground, other issues may arise. Ground rod diameters may vary. For example, ground rod diameters for a particular ground rod may be allowed to vary by +/−0.005″ per certain standards and codes. Current solutions for managing interference/press fit connections to accommodate the full tolerance band of ground rods is to ovalize the ground rod port of interference/press fit type connectors during manufacture.

A need exists for other effective options facilitating the connection of interference/press fit type connectors to the full tolerance band of ground rods.

### SUMMARY

The present disclosure provides embodiments of a ground connector for securing to a ground rod, the ground connector including a rod comprising a longitudinal passageway extending through at least a portion of the rod. The longitudinal passageway includes a first section having a first inner diameter, and a second section having a second inner diameter different than the first inner diameter, wherein the first section having the first inner diameter is nearest an opening to the passageway and transitions to the second section having the second inner diameter in a step-like manner.

The present disclosure also provides embodiments of a ground connector for securing to a ground rod, the ground conductor including a rod including a longitudinal passageway extending through at least a portion of the rod, the longitudinal passageway including a first section having a first inner diameter, a second section having a second inner diameter, and a third section having a third inner diameter. The first, second and third inner diameters are different and wherein the first section transitions to the second section in a step-like manner and the second section transitions to the third section in a step-like manner.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is an exploded perspective view of a ground system for describing portions of the ground system according to illustrative embodiments of the present disclosure;

FIG. 2 is a view of the ground system depicted in FIG. 1 for describing portions of the ground system according to illustrative embodiments of the present disclosure;

FIG. 3 is a cross-sectional view of a ground connector of the same inventor for describing aspects of the ground connector;

FIG. 4 is an exploded perspective view of a ground connector according to an illustrative embodiment of the present disclosure;

FIG. 5 is a perspective view of the ground connector according an illustrative embodiment of the present disclosure;

FIG. 6 is a cross-sectional view of the ground connector taken along lines 6-6 of FIG. 4 according to an illustrative embodiment of the present disclosure;

FIG. 6A is an enlarged view of a portion of FIG. 6 for describing aspects of the ground connector according to an illustrative embodiment of the present disclosure;

FIG. 6B is an enlarged view of a portion of FIG. 6 for describing aspects of the ground connector according to an illustrative embodiment of the present disclosure;

FIG. 6C is an enlarged view of a portion of FIG. 6 for describing aspects of the ground connector according to an illustrative embodiment of the present disclosure;

FIGS. 7A-7C are enlarged views of portions of the ground connector according to illustrative embodiments of the present disclosure;

FIG. 8 is a cross-sectional view of a ground connector according to another illustrative embodiment of the present disclosure; and

FIG. 9 is a cross-sectional view of a ground connector according to another illustrative embodiment of the present disclosure.

### DETAILED DESCRIPTION

The present disclosure provides embodiments of multi-step tapered ground connectors used to electrically connect, for example, ground conductors to ground rods. For ease of description, the multi-step tapered ground connector may be referred to as the “connector” or “ground connector” in the singular and the “connectors” or “ground connectors” in the plural.

The ground conductors may be referred to as the “ground conductor” in the singular and the “ground conductors” in the plural. The ground rods may be referred to as the “ground rod” in the singular and the “ground rods” in the plural. It is noted that the ground conductors can be solid conductors or they can be stranded conductors. The ground connector may include one or more ports, slots, channels, apertures or other openings that receive the ground conductor and may be referred to as the “connector opening” in the singular and the “connector openings” in the plural. The ground connector may include one or more ports, slots, channels, apertures or other openings that receive the ground rod and may be referred to as the “ground rod opening” in the singular and the “ground rod openings” in the plural.

The present disclosure may refer to surfaces transitioning from a surface having a first diameter to a surface having a second diameter as transitioning in a step-like manner. The step-like manner of transition may be abrupt at, for example, 90 degree angles. Alternatively, the step-like manner of transition may be more of a short abrupt ramp transitioning from the first diameter to the second diameter. According to various embodiments, the ramp may be flat or concave as described later herein.

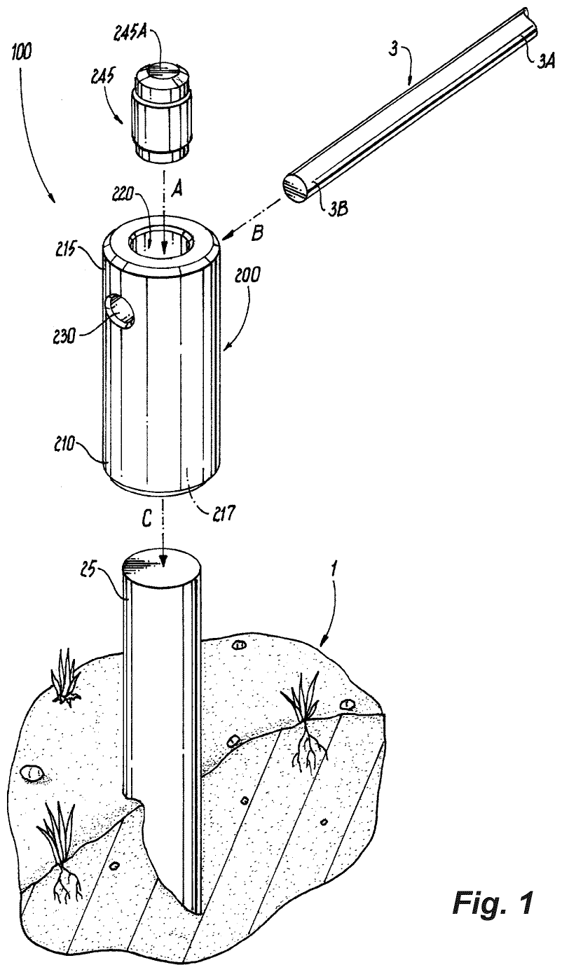

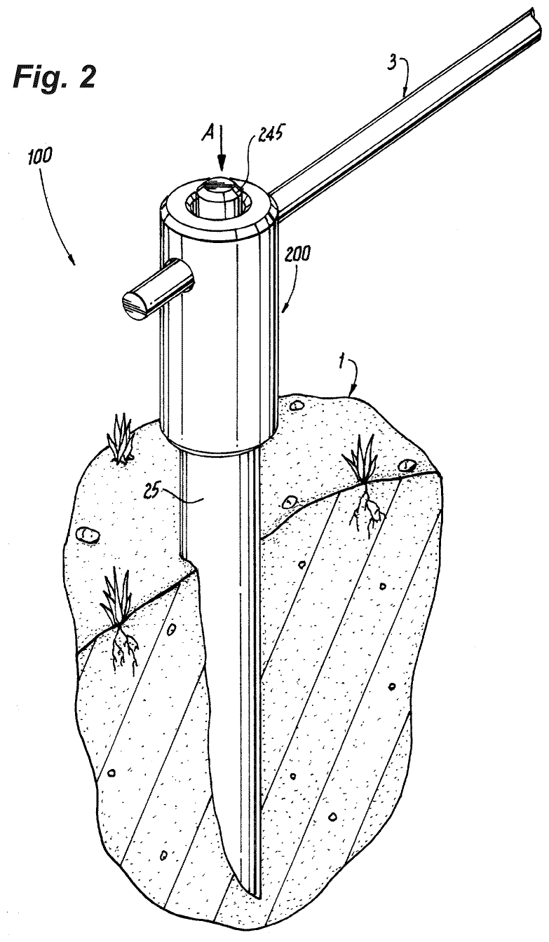

A ground rod system 100 according to an illustrative embodiment of the present disclosure is shown in FIGS. 1 and 2. Ground rod system 100 includes a ground rod 25 that may be inserted into the earth 1 to ground various types of electrical applications. A ground connector 200 according to an illustrative embodiment of the present disclosure is mounted to ground rod 25. A proximal end 3A of a ground conductor 3 is electrically connected to an electrical appliance (not shown). The distal end 3B of the ground conductor 3 is passed at least partially through opening 230 in connector 200 and is secured to connector 200 utilizing pin 245. The end 25A of ground rod 25 is positioned at the opening to passageway 217 of connector 200. As will be described in greater detail later below, passageway 217 has two or more sections each having a different diameter. According to an embodiment of the present disclosure, the passageway 217 has three separate sections with decreasing diameters. For example, the diameter of the section of the passageway closest to the opening to passageway 217 has the largest diameter and the next section has a smaller diameter and the final section furthest from the opening to the passageway 217 has the smallest diameter.

Ground rod 25 may be a substantially cylindrical member, although at least portions of ground rod 25 may be other shapes including, for example, conical, frustoconical, rectangular, etc. Ground rod 25 may include a conical portion or point at one or more ends facilitating being inserted into the ground. Ground rod 25 may be formed from one or more metallic materials including, for example, copper clad steel. Ground rod 25 may be sufficiently long to be driven up to 8′ or deeper into the earth 1. The actual diameter of ground rod 25 may vary, depending on various factors. For example, the diameter of ground rod 25 may vary depending on environmental conditions including, for example, the temperature at which the ground rod has been stored. Moreover, as noted above, ground rod diameters may be allowed to vary during manufacture per certain standards and codes. For purposes of illustration and description herein, the diameter is described as varying by +/−0.005″. Of course, the amount of variation can change over time and from standard to standard and from code to code. Accordingly, for description purposes, the ground rods described herein have a nominal diameter that may vary by up to 0.010″ (between max and min) depending on the manufacture and/or manufacturing process used to make the ground rod. An exemplary ground rod 25 for description purposes might have a nominal diameter of ⅝″ (0.625″). This diameter may be allowed to vary by +/−0.005″, resulting in a minimum allowable diameter of 0.620″ and a maximum allowable diameter of 0.630″. Ground rod 25 may be driven into the earth 1 by hand utilizing a hammer or mechanically utilizing a mechanical rotary hammer.

The user passes the distal end 3B of ground conductor 3 in direction “B” through the opening 230 in connector 200. Pin 245 is pressed down in direction “A” into first passage 220. Connector 200 may then be placed on ground rod 25 which may or may not have already been driven into the earth 1. Using a hammer or a mechanical rotary hammer, pin 245 is driven into opening 230 and at the same time, ground rod 25 is driven up into passageway 217 as ground rod 25 is driven into the earth 1. As the ground rod 25 passes through the decreasing diameter sections in passageway 217, the interference fit between the ground rod 25 and connector 200 will improve.

A ground connector similar in certain aspects to that described herein with respect to illustrative embodiments of the present disclosure is shown in cross-section in FIG. 3. Such a ground connector is described in detail in International Application No. PCT/US2024/011184 (the PCT application) to the inventor of the present application and the contents of which are incorporated herein in their entirety by reference. In particular, the PCT application describes in detail a rod 100 that includes an elongated body 105 with a first end 110 (e.g., a bottom end) and a second end 115 (e.g., a top end) opposite to the first end 110. The rod 100 is described as a sleeve for connecting to the ground rod 25 that is inserted into the earth. The first end 110 of the rod 100 includes a passageway 117 that extends longitudinally along a first axis 125 of the elongated body 105. Passageway 117 has a generally smooth constant inner diameter and is capable of receiving a ground rod 25 using a friction fit or press fit. The second end 115 of the rod 100 includes a first passage 120 which may have a substantially cylindrical opening. The first passage 120 may extend substantially along the first axis 125 of the elongated body 105.

The passageway 117 thus extends along the first axis 125 and may be concentric with the first passage 120. The elongated body 105 may include a second passage 130 which extends along transverse axis 135 and which intersects with the first passage 120. Second passage 130 is dimensioned to receive a ground conductor. The rod 100 may include a depressed region 140 within the second passage 130. A pin 145 may be inserted and hammered into the first passage 120 and abuts and secures the ground conductor 3 to rod 100. Pin 145 is configured to alleviate problems associated with the use of prior pins. For example, pin 145 described in the PCT application is able to contact a multi-strand electrical ground conductor without causing the individual conductors being split apart.

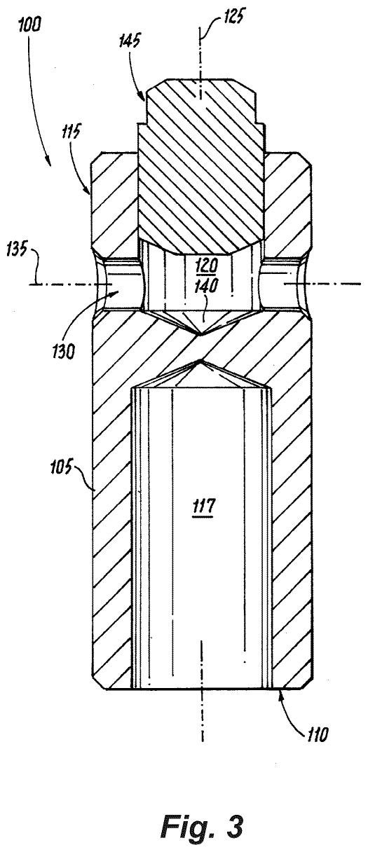

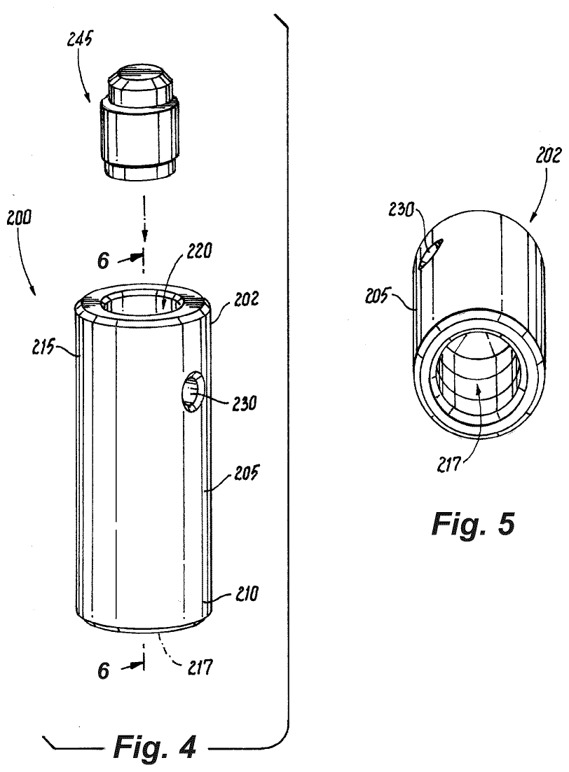

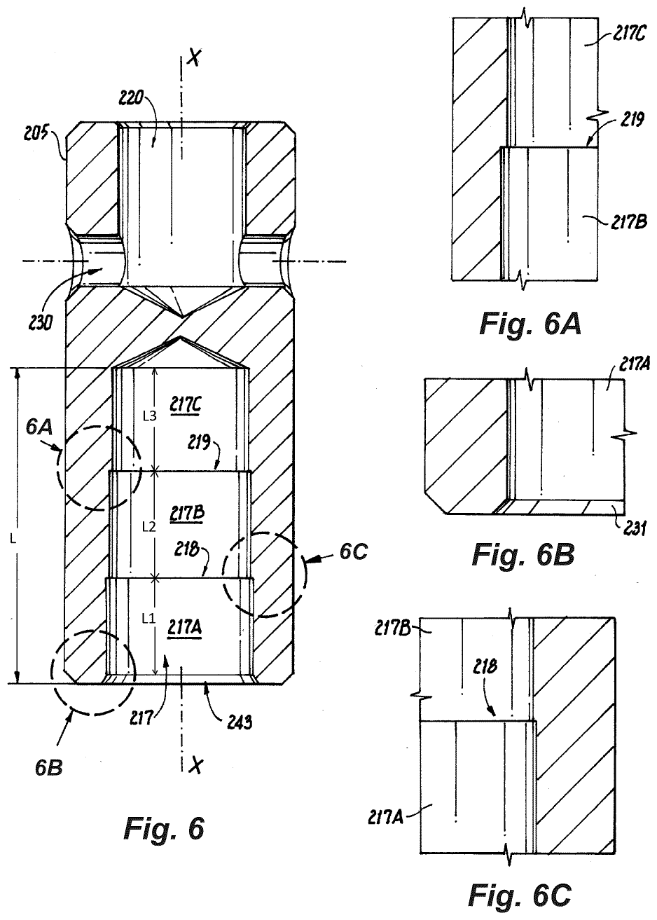

A ground connector according to an illustrative embodiment of the present disclosure is shown in FIGS. 4-6B and is referred to herein as ground connector or connector 200. According to illustrative embodiments of the present disclosure as shown in FIG. 6, instead of passageway 217 having a smooth constant diameter as described above with respect to the present inventor's PCT application, the diameter of the walls of the passageway 217 varies. For example, according to an illustrative embodiment of the present disclosure, the diameter of the passageway 217 has a constant inner diameter for a portion of its length and changes to a smaller inner diameter for another portion of its length. The passageway 217 thus has two or more portions each having a different inner diameter. According to some embodiments, the diameter of each portion changes in a stepped manner. That is, the diameter of the passageway 217 is constant for a portion of its length and the diameter changes in a step-like manner.

Connector 200 includes a rod 202 and a pin 245. Rod 202 has an elongated body 205 with a first end 210 (e.g., a bottom end) and a second end 215 (e.g., a top end) opposite to the first end 210. Rod 202 is effectively a sleeve for connecting to a ground rod 25. In particular, the first end 210 of the rod 202 includes a passageway 217 that can receive a ground rod 25 as seen in FIGS. 1 and 2, using a friction fit or press fit. The second end 215 of the rod 202 includes a first passage 220 which may have a substantially cylindrical opening and is dimensioned to receive pin 245 in an interference or press fit manner. The first passage 220 extends substantially along a first axis X of the elongated body 205 as seen in FIG. 6. First axis X extends between the first end 210 and the second end 215.

The passageway 217 also extends along the first axis X and may be concentric with the first passage 220. The elongated body 205 may include a second passage 230 that intersects with the first passage 220. The second passage 230 is dimensioned to receive a ground conductor. A pin 245, similar to pin 145 described in the inventor's above-noted PCT application, is dimensioned to provide a friction or press fit in first passage 220. Pin 245 may be inserted into the first passage 220 and hammered down against the ground conductor 3 as seen in FIG. 1 extending through second passage 230 securing the ground conductor 3 to the connector 200.

According to embodiments of the present disclosure, passageway 217 may include two or more different inner diameter sections that transition in a stepped manner. For example, according to the illustrative embodiment of the present disclosure depicted in FIG. 6, passageway 217 includes three different inner diameter sections. As depicted in FIGS. 6-6C, passageway 217 includes three different inner diameter sections 217A, 217B and 217C. First section 217A is provided at opening 243 to passageway 217 and has the largest inner diameter. For example, the inner diameter of the first section 217A is dimensioned, for example, to correspond to and fit a ground rod 25 having the largest allowable outer diameter for the ground rod 25 (e.g., nominal diameter +0.005″). First section 217A has a length L1 which extends from opening 243 for approximately ⅓ the length of passageway 217 and transitions at step 218 to second section 217B. Second section 217B has an inner diameter dimensioned to correspond to and fit a ground rod 25 having a nominal outer diameter for that ground rod 25. Second section 217B has a length L2 which extends from step 218 for approximately ⅓ the length of passageway 217 and transitions at step 219 to third section 217C. Third section 217C has an inner diameter dimensioned to correspond to and fit a ground rod having the smallest allowable outer diameter for the ground rod (e.g., nominal diameter −0.005″). Third section 217C has a length L3 which extends from step 219 for approximately ⅓ the length of passageway 217. The opening 243 to passageway 217 includes a severe chamfer 231 as shown and acts as a guide and additional directional support as the ground rod 25 is inserted into the passageway 217. While the lengths L1, L2 and L3 of sections 217A, 217B and 217C, respectively, are described as being substantially the same (e.g., ⅓ the length of passageway 217), one or more of the sections 217A, 217B and 217C may be longer or shorter than the other sections. Each section 217A, 217B and 217C may have a different length.

Connector 200 may be mounted to a ground rod 25 by hand utilizing a hammer or mechanically utilizing a mechanical rotary hammer. Pin 245 is similar to pin 145 described in the inventor's above-noted PCT application. It is noted that since the first section 217A of passageway 217 at opening 243 has the largest inner diameter and corresponds to the largest allowable outer diameter for the ground rod 25, connector 200 can be easily slid onto ground rods 25 having nominal diameter sizes. As the ground rod 25 is pressed or driven further into the passageway 217, the inner diameter of the passageway 217 decreases at step 218 to second section 217B and further decreases at step 219 to third section 217C. As the ground rod 25 passes through these decreasing inner diameter sections of passageway 217, the interference fit between the ground rod 25 and connector 200 will improve. The inner walls at steps 218 and 219 of passageway 217 may also tend to shear as the ground rod passes through the decreasing inner diameter sections providing the maximum possible interference fit for the ground rod 25.

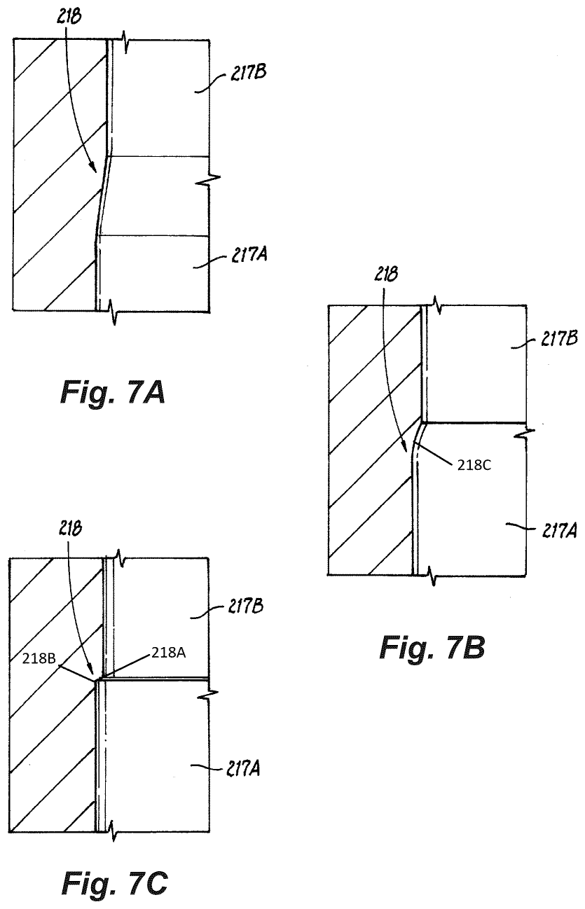

As shown in FIGS. 6A and 6C, the step-like manner of the transitions between steps 218 and 219 have generally abrupt bends or transitions between sections. For example, according to an embodiment of the present disclosure, steps 218, 219 may have generally 90 degree bends or transitions. According to other illustrative embodiments of the present disclosure, the step-like manner of the transition between steps 218 and 219 may be configured in other ways. For example, according to an illustrative embodiment as depicted in FIG. 7A, the step-like manner of the transition from the larger inner diameter section 217A to the smaller inner diameter section 217B is in the form of a flat ramp 218. A similar ramp may be provided at step 219. As shown in FIG. 7B, instead of the flat ramp depicted in FIG. 7A, the ramp at step 218 may be rounded off. For example, the ramp at step 218 may include a concave inner surface 218C at the transition from the first section 217A to the second section 217B. A similar ramp may be provided at step 219. According to another illustrative embodiment of the present disclosure as depicted in FIG. 7C, step 218 includes a rounded off convex outer edge nose 218A. The base 218B of the step 218 may also include a rounded off concave inner edge 218B. Step 219 may be rounded off in similar manner.

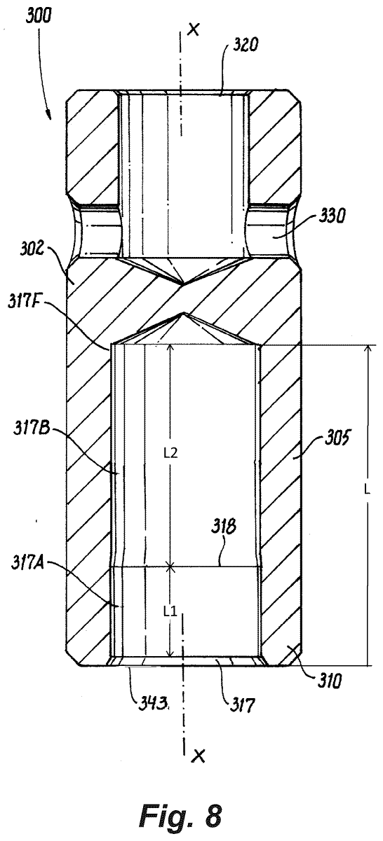

A ground connector according to another illustrative embodiment of the present disclosure is shown in cross-section in FIG. 8 and is referred to herein as ground connector or connector 300. Connector 300 includes a rod 302 and a pin (not shown) similar to pin 245 described above with respect to other embodiments. Rod 302 has an elongated body 305 with a first end 310 (e.g., a bottom end) and a second end 315 (e.g., a top end) opposite to the first end 310. Rod 302 is effectively a sleeve for connecting to a ground rod 25. In particular, the first end 310 of the rod 302 includes a passageway 317 that can receive a ground rod 25 using a friction fit or press fit. The second end 315 of the rod 302 includes a first passage 320 which may have a substantially cylindrical opening and is dimensioned to receive pin 245 (not shown) in an interference or press fit manner. The first passage 320 extends substantially along a first axis X of the elongated body 305. First axis X extends between the first end 310 and the second end 315.

The passageway 317 also extends along the first axis X and may be concentric with the first passage 320. The elongated body 305 may include a second passage 330 that intersects with the first passage 320. The second passage 330 is dimensioned to receive a ground conductor 3. A pin, similar to pin 145 described in the inventor's above-noted PCT application, may be inserted into the first passage 320 and hammered down against the ground conductor 3 extending through second passage 330 securing the ground conductor 3 to the connector 300.

According to embodiments of the present disclosure, passageway 317 has a length “L” and may include two or more different inner diameter sections that transition in a stepped manner similar to that described in the above embodiments. According to the illustrative embodiment of the present disclosure depicted in FIG. 8, two different inner diameter sections are provided. As depicted in FIG. 8, passageway 317 includes two different inner diameter sections 317A and 317B. First section 317A is provided at opening 343. The inner diameter of first section 317A is constant. According to the present embodiment, first section 317A has the largest inner diameter and is dimensioned, for example, to correspond to and receive the largest allowable outer diameter for the ground rod 25 (e.g., nominal diameter +0.005″). First section 317A has a length L1 which extends from opening 343 for approximately ⅓ the length “L” of passageway 317 and transitions at step 318 to second section 317B. According to an embodiment of the present disclosure, second section 317B has a constant inner diameter dimensioned to correspond to and receive the smallest allowable outer diameter (e.g., nominal diameter −0.005″) of the ground rod. Second section 317B has a length “L2” and extends ⅔ the length “L” of passageway 317 from step 318 to end section 317F. According to another embodiment of the present disclosure, the inner diameter of second section 317B is constant, extends approximately ⅔ the length “L” of passageway 317 from step 318 to end section 317F and is dimensioned to correspond to and receive a ground rod with the nominal outer diameter. According to another embodiment, instead of having a constant inner diameter, the second section 317B at step 318 has an inner diameter dimensioned to correspond to the nominal outer diameter of the ground rod and then tapers for ⅔ the length “L” of passageway 317 to an inner diameter dimensioned to correspond to the smallest allowable outer diameter for the ground rod (e.g., nominal diameter −0.005″) at end 317F of passageway 317.

Connectors 200 and 300 may be mounted to a ground rod 25 by hand utilizing a hammer or mechanically utilizing a mechanical rotary hammer. It is noted that since the first section 217A and section 317A at opening 243 and 343, respectively, have the largest inner diameter and correspond to the largest allowable outer diameter for the ground rod 25, connectors 200 and 300 can be easily slid onto ground rods 25 having nominal outer diameter sizes. As the ground rod 25 is pressed or driven further into the passageway 217 and passageway 317, the inner diameter of the passageway decreases. As the ground rod 25 passes through these decreasing inner diameter sections, the interference fit between the ground rod 25 and connectors 200 and 300 will improve. The inner walls at steps 218, 219 and 318 may also tend to shear providing the maximum possible interference fit for the ground rod 25.

As noted above, an exemplary ground rod 25 for discussion purposes might have a nominal outer diameter of ⅝″ (0.625 ″) and is allowed to vary by +/−0.005″, resulting in a minimum allowable diameter of 0.620″ and a maximum allowable diameter of 0.630″. The inner diameters of the first, second and third portions of passageway 217 and passageway 317 as described above are selected accordingly. For example, for a ⅝″ ground rod 25, the first section 217A has an inner diameter dimensioned to receive a ground rod 25 having an outer diameter of up to 0.630″. Second section 217B has an inner diameter dimensioned to receive a ground rod 25 having a nominal outer diameter (e.g., 0.625″). Third section 217C has an inner diameter dimensioned to receive a ground rod 25 having a smallest allowable diameter (e.g., 0.620″).

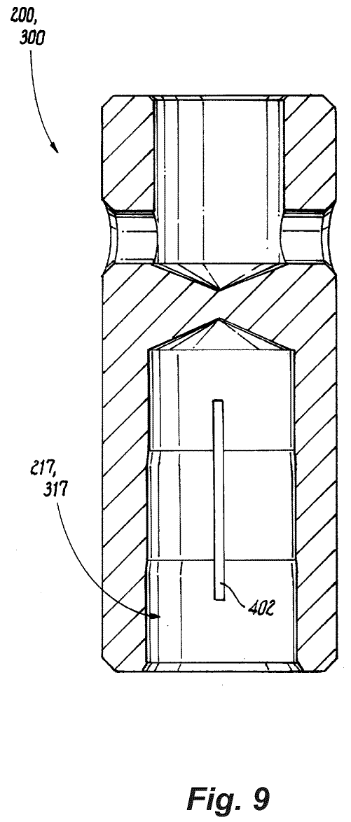

It may be beneficial for the end user to see how far the ground cable 25 has been driven into the passageway 217 and passageway 317. This can be achieved by marking the ground cable appropriately prior to hammering the connector 200, and connector 300 onto the ground cable. For example, assuming each of the sections 217A-217C of the connector is ½″ in length, the user can mark the ground cable 1.5″ from the distal end. As the connector is hammered onto the ground cable 25, the distance the ground cable 25 has been driven into the passageway 217 and passageway 317 can be readily determined by looking at the mark. According to another illustrative embodiment of the present disclosure, one or more “windows” or slotted openings 402 can be provided in the connector 200 and connector 300 as shown in FIG. 9. This window 402 allows the end user to readily see whether the ground cable 25 has been sufficiently driven into passageway 217 and passageway 317.

Embodiments of the present disclosure ensure radial contact across the full circumference of the mating surface between the ground rod 25 and connector 200 or 300, reducing the overall installation depth required for the connector to meet mechanical requirements and improving the area available for current flow.

Certain terminology may be used in the present disclosure for ease of description and understanding. Examples include the following terminology or variations thereof: top, bottom, up, upward, upper inner, outer, outward, down, downward, upper, lower, vertical, horizontal, etc. These terms refer to directions in the drawings to which reference is being made and not necessarily to any actual configuration of the structure or structures in use and, as such, are not necessarily meant to be limiting.

As shown throughout the drawings, like reference numerals designate like or similar corresponding parts. While illustrative embodiments of the present disclosure have been described and illustrated above, it should be understood that these are exemplary of the disclosure and are not to be considered as limiting. Various portions of the described embodiments may be mixed and matched depending on a particular application. Additions, deletions, substitutions, and other modifications can be made without departing from the spirit or scope of the present disclosure. Accordingly, the present disclosure is not to be considered as limited by the foregoing description.

What is claimed is:

1. A ground connector for securing to a ground rod, the ground connector comprising:
a rod comprising a longitudinal passageway extending through at least a portion of the rod, the longitudinal passageway comprising,
a first section having a first inner diameter, and
a second section having a second inner diameter different than the first inner diameter, wherein the first section having the first inner diameter is nearest an opening to the passageway and transitions to the second section having the second inner diameter in a step-like manner.

2. The ground connector according to claim 1, wherein the passageway further comprises a third section having a third inner diameter different than the first inner diameter and the second inner diameter.

3. The ground connector according to claim 2, wherein the third section of the passageway is furthest from the opening to the passageway and wherein the second section of the passageway transitions to the third section of the passageway in a step-like manner.

4. The ground connector according to claim 2, wherein the first inner diameter is selected based on a largest allowable outer diameter of the ground rod.

5. The ground connector according to claim 4, wherein the second inner diameter is selected based on a nominal allowable outer diameter of the ground rod.

6. The ground connector according to claim 5, wherein the third inner diameter is selected based on a smallest allowable outer diameter of the ground rod.

7. The ground connector according to claim 1, further comprising a perpendicular passageway perpendicular to the longitudinal passageway and dimensioned to receive a ground conductor.

8. The ground connector according to claim 7, further comprising a second longitudinal passageway intersecting the perpendicular passageway and dimensioned to receive a pin for securing the ground conductor to the ground connector.

9. The ground connector according to claim 1, wherein the step-like manner in which the first section transitions to the second section comprises a flat ramp.

10. The ground connector according to claim 1, wherein the step-like manner in which the first section transitions to the second section comprises a concave ramp.

11. A ground connector for securing to a ground rod, the ground connector comprising:
a rod comprising,
a longitudinal passageway extending through at least a portion of the rod, the longitudinal passageway comprising,
a first section having a first inner diameter,
a second section having a second inner diameter, and
a third section having a third inner diameter,
wherein the first, second and third inner diameters are different and wherein the first section transitions to the second section in a step-like manner and the second section transitions to the third section in a step-like manner.

12. The ground connector according to claim 11, wherein the first inner diameter is selected based on a largest allowable outer diameter of the ground rod.

13. The ground connector according to claim 12, wherein the second inner diameter is selected based on a nominal allowable outer diameter of the ground rod.

14. The ground connector according to claim 13, wherein the third inner diameter is selected based on a smallest allowable outer diameter of the ground rod.

15. The ground connector according to claim 11, further comprising a perpendicular passageway perpendicular to the longitudinal passageway and dimensioned to receive a ground conductor.

16. The ground connector according to claim 15, further comprising a second longitudinal passageway intersecting the perpendicular passageway and dimensioned to receive a pin for securing the ground conductor to the ground connector.

17. The ground connector according to claim 11, wherein the step-like manner in which the first section transitions to the second section and the second section transitions to the third second comprises at least one of a flat ramp and a concave ramp.

18. The ground connector according to claim 11, wherein the step-like manner in which the first section transitions to the second section comprises a concave ramp.
